(19) United States
(12) Patent Application Publication
(10) Pub. No.: US 2009/0040061 A1
(43) Pub. Date: Feb. 12, 2009

(54) Apparatus and system for monitoring tool use

(76) Inventors: Witold GOLUNSKI, Gdansk (PL); Sylvia Selby, Leicester (GB)

Correspondence Address: YOUNG LAW FIRM, P.C.;ALAN W. YOUNG, 4370 ALPINE ROAD, SUITE 106, PORTOLA VALLEY, CA, 94028, US

(21) Appl. No.: 12/050,129

(22) Filed: Mar. 17, 2008

(30) Foreign Application Priority Data
Mar. 17, 2007 (GB) 0705175.8.8
May 1, 2007 (GB) 0708386.8

(51) Int. Cl. G07C 3/02; G08B 21/00

(52) U.S. Cl. 340/683; 377/16

(57) ABSTRACT

An apparatus and system for monitoring usage of one or more power tools, the system comprising setting means by which a prescribed extent of usage of a tool can be set. The prescribed extent of usage is determined by conversion of usage units into time units using a conversion function specific to said tool, wherein the conversion function is dependent upon operational characteristics of said tool. The apparatus or system further comprise sensing means for sensing usage of a tool, timing means for timing the duration of usage of the tool in accordance with said sensing means, and control means arranged to provide indication when the timed duration of usage of said tool reaches or exceeds the prescribed duration.

This application claims priority under 35 U.S.C. §119(a)-(d) of Application No. GB 0708386.8, previously filed on Mar. 17, 2007, which application is hereby incorporated herein by reference in its entirety.

The present invention relates to manually operated tools and more particularly to a method and apparatus for monitoring tool usage specific to the vibration of the tool during use.

The Applicant has co-pending applications stemming from International Application PCT/GB2005/002660, which describe a tool monitoring device, referred to as a “Tool Timer.” PCT/GB2005/002660 is concerned primarily with the timing of tool use for the purpose of scheduling maintenance and servicing in order to prevent or reduce the effects of excessive vibration caused by power tools. Such vibrations can pose significant health and safety risks for a user if not properly monitored.

The present invention relates to developments over and above the original concepts described in that earlier application and represents a new invention, which focuses on more effective monitoring and management of the degree of vibration to which a tool operator is exposed.

It is an object of the present invention to provide an improved tool monitoring apparatus and system, which can better account for health and safety risks associated with use of a particular tool.

According to a first aspect of the present invention there is provided a system for monitoring usage of one or more power tools, the system comprising: setting means by which a prescribed extent of usage of a tool can be set, the prescribed extent being based upon conversion of usage units into time units or vice versa using a conversion function specific to said tool, wherein the conversion function is dependent upon operational characteristics of said tool; sensing means for sensing usage of a tool; timing means for timing the duration of usage of the tool in accordance with said sensing means; and, control means arranged to provide indication when the timed duration of usage of said tool reaches or exceeds the prescribed duration.

The system of the present invention is particularly advantageous since it can cater for various different forms of power tools, each of which are to be used within predetermined safety limits. Thus the health and safety risk to which a user is exposed can be controlled by tailoring the usage allotment to suit a tools operational characteristics. A tool which carries a high usage risk will have a higher conversion function and so the usage units will count down quickly during use of the tool. A tool which carries a lower risk will have a lower conversion function and so the prescribed duration for which that tool can be safely used will be increased.

The extent of usage of the tool is typically defined by way of a time period.

Preferably the conversion function is a risk ratio. In one embodiment the conversion function is based upon the vibrations produced by a tool during use. The conversion function may account for both amplitude and frequency of vibration of the tool. Thus a user's exposure to harmful operational tool vibrations can be controlled.

In the context of the present invention, power tools comprise any manually operated tools arranged to be driven by an internal or external power source during use. The power source may be, for example, pneumatic, hydraulic, electric or a fuel for powering a motor, engine or other actuable means.

Prescribing arbitrary usage units according to the present invention allows a broad spectrum of tools to be monitored such that the present invention is not limited to any particular tool type or vibration frequency. Thus the present invention is applicable to conventional hand tools, high-frequency power tools as well as larger machinery.

According to one preferred embodiment, the control means is arranged to inhibit operation of the tool after the prescribed duration has expired. Typically, the system includes audio and/or visual indication means and the control means controls the indication means so as to provide a corresponding indication upon expiry of the prescribed duration. Preferably the control means operates the indication means to provide a warning to a user at a predetermined time prior to expiry of the prescribed duration and subsequently shuts down the tool upon or after expiry of the predetermined duration.

In one embodiment, the system comprises identification means for identification of an individual tool user. The identification means may comprise a portable memory means such as a keyfob or the like, on which is stored data specific to an individual user. The user data may comprise identification data and/or tool usage data indicative of the time or usage units for which the user has used specific tools. Preferably the usage data comprises usage history from which the user's level of exposure to tool vibrations over time can be determined.

Typically the system can access the data on the identification means upon operation of a tool by a user. In one embodiment the user is required to swipe in and out upon respective commencement and completion of work using a particular tool. This type of system has advantages, not only in the monitoring of health and safety factors, but also in the monitoring of productivity of one or a number of workers. Thus the present invention has the surprising advantage that it allows management of a workforce and/or engineering processes as well as human resources management in addition to health and safety factors.

In one embodiment, the system comprises a plurality of tools and central management means for monitoring the usage of the tools. Typically data relating to tool users is also stored by the central management means. Thus the operation of tools and/or processes can be overseen and managed. Preferably, a user database is maintained on the central management means, which includes the tool usage history for each user and tool.

According to one embodiment, the system comprises transmission means associated with the one or more power tools and arranged to transmit usage data to the central management means. Preferably the usage data is continually or intermittently transmitted by the transmission means so as to allow real time monitoring of tool usage from the central management means. In a preferred embodiment, the usage data is wirelessly transmitted by the transmission means. Accordingly, the system includes a receiver associated with the central management means.

The data flow in the system may be one-way such that usage data is transmitted to the central management means for monitoring purposes. Alternatively, a preferred embodiment allows two-way communication between the tool timing apparatus and the central management means such that the processing of data and control of individual tools can be carried out either at the central management means or else by the control means associated with each tool as required. The central management means may submit control and or other data in response to the usage data received from the tool. Thus two-way communication may be established in which data and/or control signals can be fed back to the tool and/or the tool control means, typically concurrently with the use of the tool.

Thus the present invention allows for an integrated downloadable system. The central processing of usage data also has the benefit of allowing the hardware required for attachment to the tool to be small and lightweight.

According to a preferred embodiment, the system is capable of distinguishing between idle tool time, in which power is supplied to the tool but the tool is not being operated, and actual tool usage or anger time, in which the tool is being operated. Preferably the sensing means senses any or any combination of power supplied to the tool, vibrational output of the tool, revolutions of the tool for a given time period and/or the operation of actuation means, such as a switch, lever or the like. In one embodiment the sensing means comprises a variable resistor.

The system may only record usage of the tool during anger time or else may alter the rate of consumption of usage units when the tool is idle. Thus the system can more accurately determine usage, productivity and associated health and safety risks for a user. Additionally, or else alternatively, the conversion function may be adjusted based on the sensed vibration characteristics of the tool. This may be achieved automatically based upon sensed vibration levels and may be conducted concurrently with usage of the tool. The sensed values may be checked either continually or else intermittently against predetermined or preset values to monitor the performance of the tool against one or more datum or reference values.

In one embodiment, access to specific system functions and data is restricted. Security measures may require the provision of input codes or identification means in order to allow access to certain data or controls. Preferably, a plurality of security levels are catered for in order to allow different people access to different functions and data. A particular user can therefore be provided with menus and/or functionality specific to their security level. One security level can be used for operation of the tool, whilst another security level may allow a user access to operational characteristics of the device such as the conversion function and/or other operational variables.

According to a second aspect of the present invention, there is provided apparatus for monitoring usage of one or more power tools, comprising: setting means by which a prescribed duration of usage of a tool can be set using a conversion function specific to said tool, wherein the conversion function is dependent upon operational characteristics of said tool; one or more sensors for sensing usage of a tool; a timer for timing the duration of usage of the tool in accordance with an output of said sensor; and, control means arranged to provide indication to a user when the timed duration of usage of said tool reaches or exceeds the prescribed duration.

It will be appreciated that tool timing apparatus according to the present invention may be provided as a stand-alone unit for connection with a tool to be monitored or else may be integral with the tool itself. Accordingly, the setting of the prescribed duration of usage for the tool may be automated by the control means based upon known operational characteristics or else may be input manually. The conversion function may be input at the time of manufacture of the tool for an integral tool timing apparatus or else may be determined automatically or manually based on known or monitored operational characteristics.

Typically the conversion function is a risk ratio associated with the tool.

The present invention may make use of existing categorization schemes in which tools are placed in categories based upon the operational risks they pose to a user. Additionally or else alternatively a risk rating or ratio may be calculated from known operational characteristics. In one embodiment, which is in many ways preferred, a risk rating or ration is calculated by monitoring tool characteristics during tool usage. Thus the risk ratio and hence the predetermined usage duration may be calculated automatically based upon sensor readings. The allowed usage may also be adjusted to reflect current operational characteristics of the tool.

Alternatively the operational characteristics may be manually input and the prescribed duration calculated and set automatically. Alternatively the prescribed may be calculated and input manually using manual setting means, typically in the form of a keypad.

According to a third aspect of the present invention, there is provided a system for monitoring usage of one or more tools by one or more users, the system comprising user identification means associated with the or each individual user, user recognition means associated with the or each tool and monitoring means for determining usage of the or each tool, wherein the identification means specific to a particular user is recognisable by the recognition means associated with a specific tool prior to use of said tool by said user such that a period of usage of said tool by said user is automatically recordable by way of said monitoring means, wherein the system comprises control means arranged to control operation of said tool when said period of usage exceeds a predetermined period.

Thus the usage of a number of different tools by one or more users can be monitored and the health and safety risks managed accordingly. The control of the tool may comprise control of indication means and/or control of the operation of the tool. Typically the identification means is portable and may comprise transmission means and/or a memory, such as, for example, a key fob.

A tool may be inoperative until the recognition means recognizes identification means associated with any one of a predetermined number of users. This may be achieved using a cut-out means which inhibits the flow of power or fluid to the tool. Thus a user may be required to swipe in and swipe out at the start and end of a period of usage of a tool or else a user may be recognized by way of data via an IR or a local wireless network.

According to a fourth aspect of the present invention, there is provided apparatus for monitoring usage of a power tool, the apparatus comprising vibration sensing means for sensing a characteristic of vibrations generated by use of said tool, timing means for recording a time period during which said characteristic is sensed; control means arranged to compare the characteristic of said vibrations over the timed period against a threshold value of tool usage; and, indication means arranged to indicate to a user when the sensed characteristic or duration reaches or exceeds the threshold value of tool usage.

Thus the present invention allows the actual vibration levels to be monitored over a period of time in order to determine a user's exposure to injury risks associated with vibrations. Thus the operational characteristics do not need to be known in advance but can be determined upon use of the tool. This allows for greater precision and can also take account for variations in operational characteristics throughout the life of the tool as well as the use of associated consumables.

This aspect may be incorporated as part of the system or apparatus according to any other aspect of the present invention.

In one embodiment, the characteristics comprise any or any combination of vibration amplitude, frequency, direction or cyclic variations thereof. In one simplified example, a greater frequency of vibration experienced by a user may result in a shorter threshold time being prescribed for the tool. However it will be appreciated that multiple characteristics may be considered in determining the suitable usage threshold for a given tool.

In one embodiment, the threshold may be automatically set by the control means. The threshold may be predetermined for a given period of usage or else may vary dynamically during use of the tool.

According to a preferred embodiment, the vibration sensing means comprises a piezoelectric transducer and preferably the sensing means comprises a piezoelectric accelerometer. Typically the piezoelectric member comprises a piezochrystal. Preferably the vibration sensing means comprises vibration frequency conversion means to convert tool operational frequencies to a suitable range for actuation of the piezoelectric member.

The sensing means may be integral with a tool housing or else attachable thereto for use. In one embodiment, the sensing means may be provided as part of a portable unit which is selectively attachable to a plurality of different tools for use. Preferably the portable unit comprises identification means, typically in the form of data stored on a memory, in order to identify an individual user carrying the unit.

Other conventional identification means such as, for example, a bar code or magnetic strip will be apparent to the skilled person as well as the possibility of identification of the user by WiFi or IR signals.

Specific embodiments of the present invention are described in further detail below by way of example with reference to the accompanying drawings, of which:

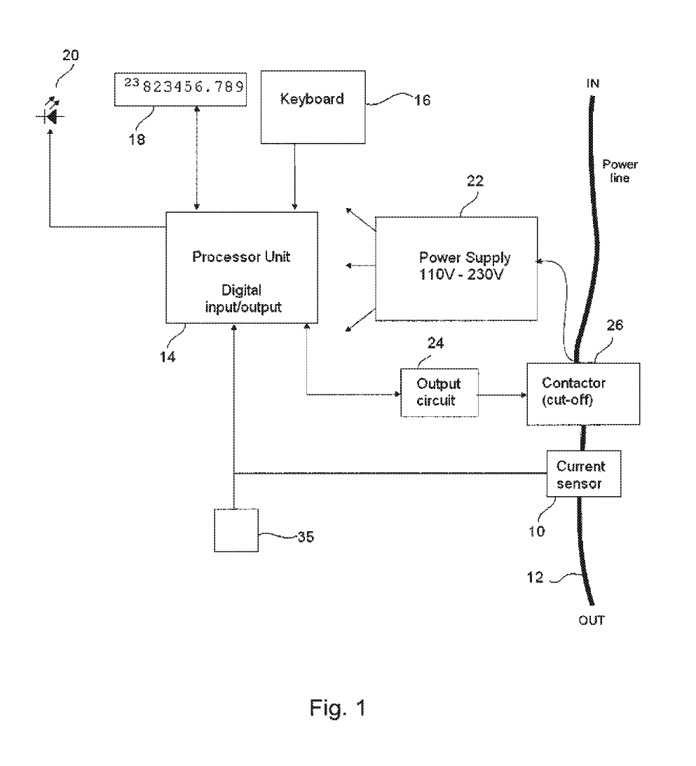

FIG. 1 is a schematic showing the basic components of a tool monitoring apparatus according to a first embodiment of the present invention;

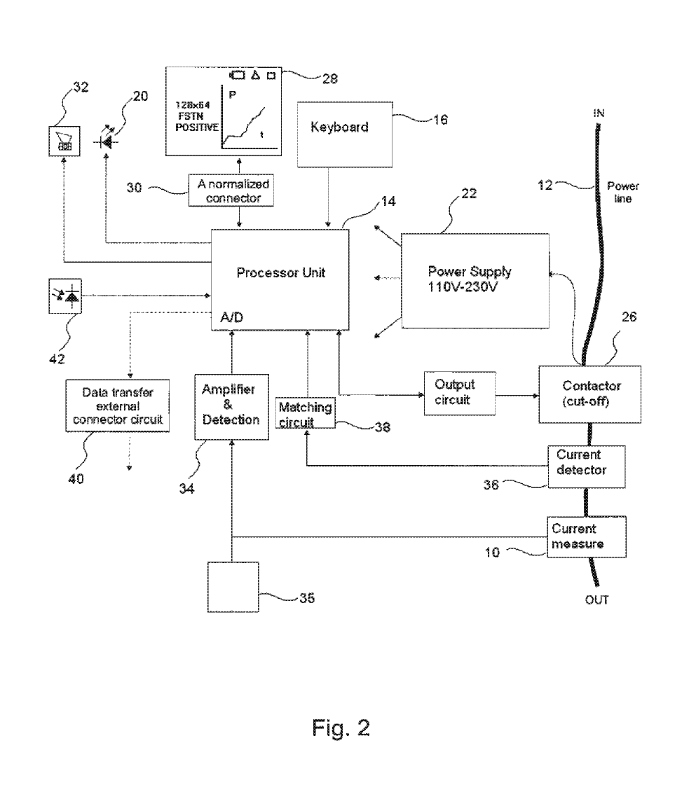

FIG. 2 shows a schematic of the basic components according to a second embodiment of the present invention;

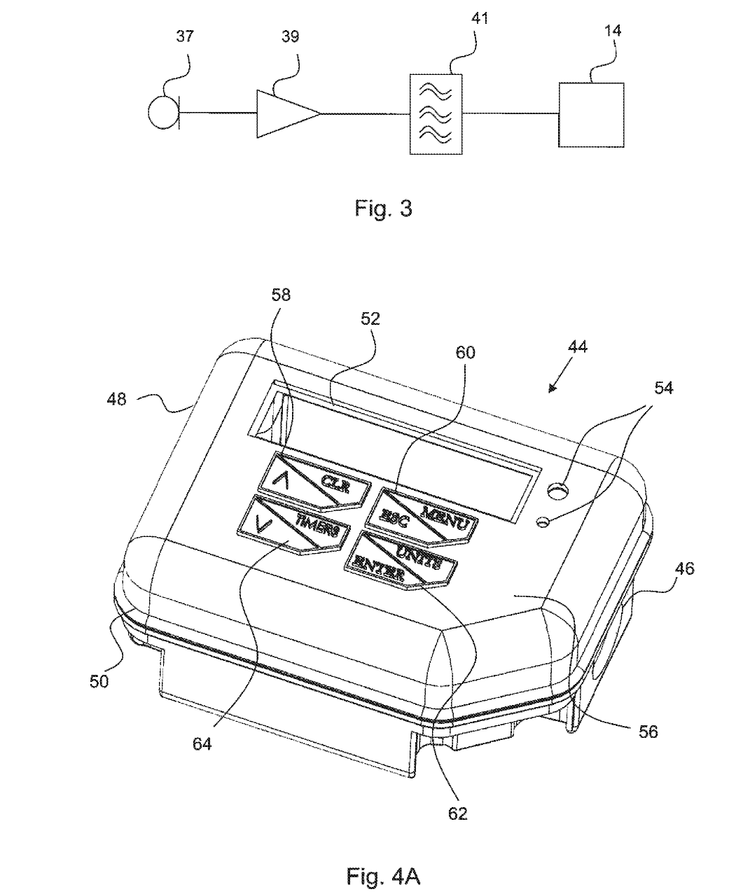

FIG. 3 shows the basic electronic components associated with a sensing means according to one embodiment of the present invention;

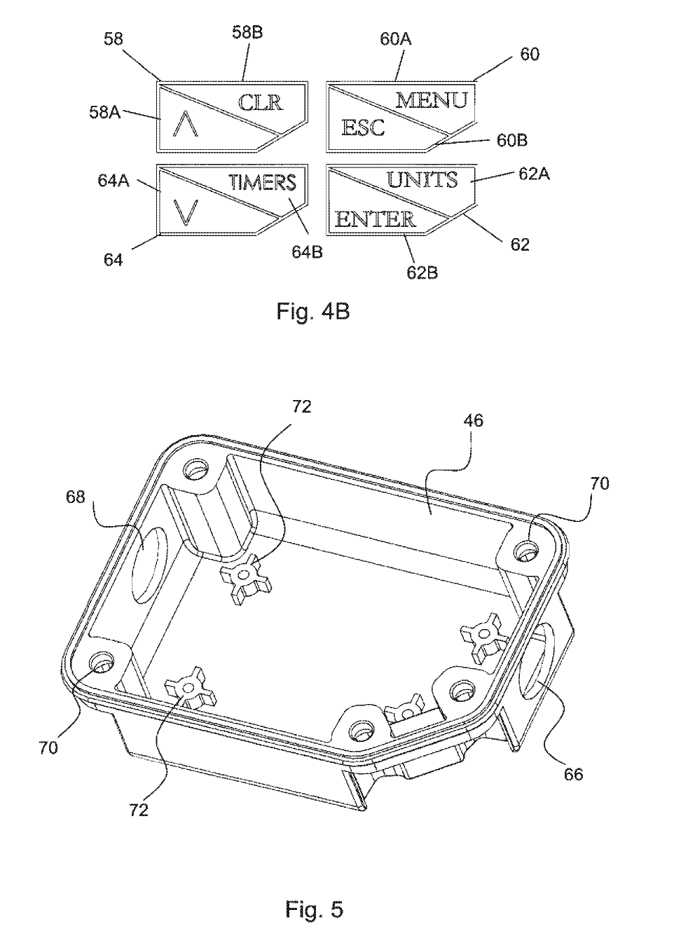

FIGS. 4A and 4B show an embodiment of a product housing for an apparatus according to the present invention;

FIG. 5 shows the base of the housing of FIG. 4;

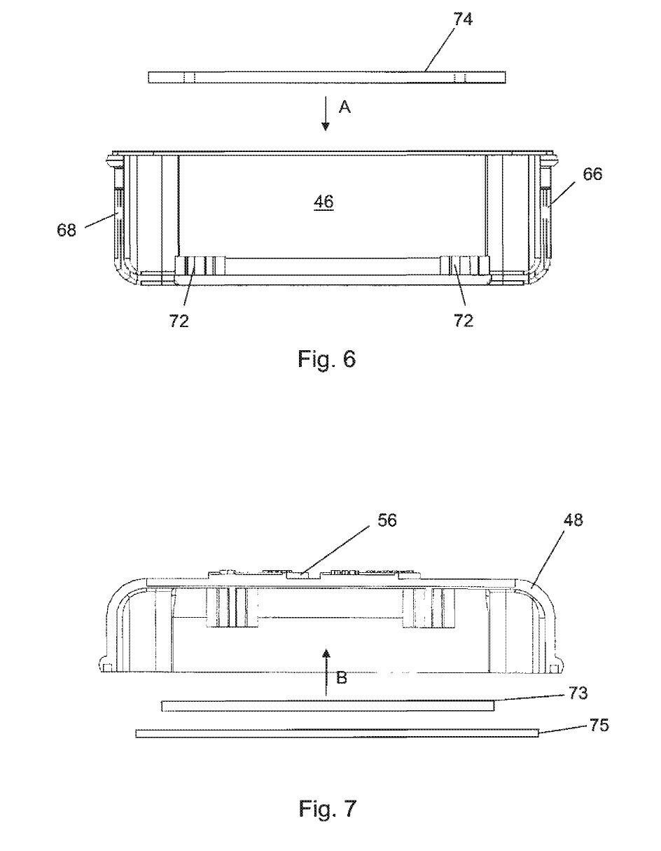

FIG. 6 shows a cross-sectional view of the base housing shown in FIG. 5;

FIG. 7 shows a cross-sectional view of the housing lid shown in FIG. 4;

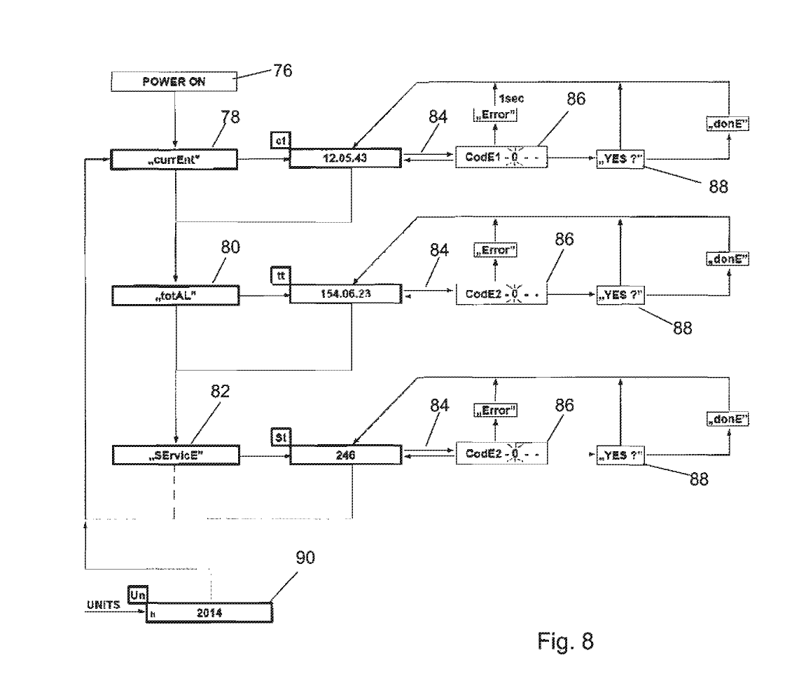

FIG. 8 shows steps for setting an apparatus according to one embodiment of the present invention;

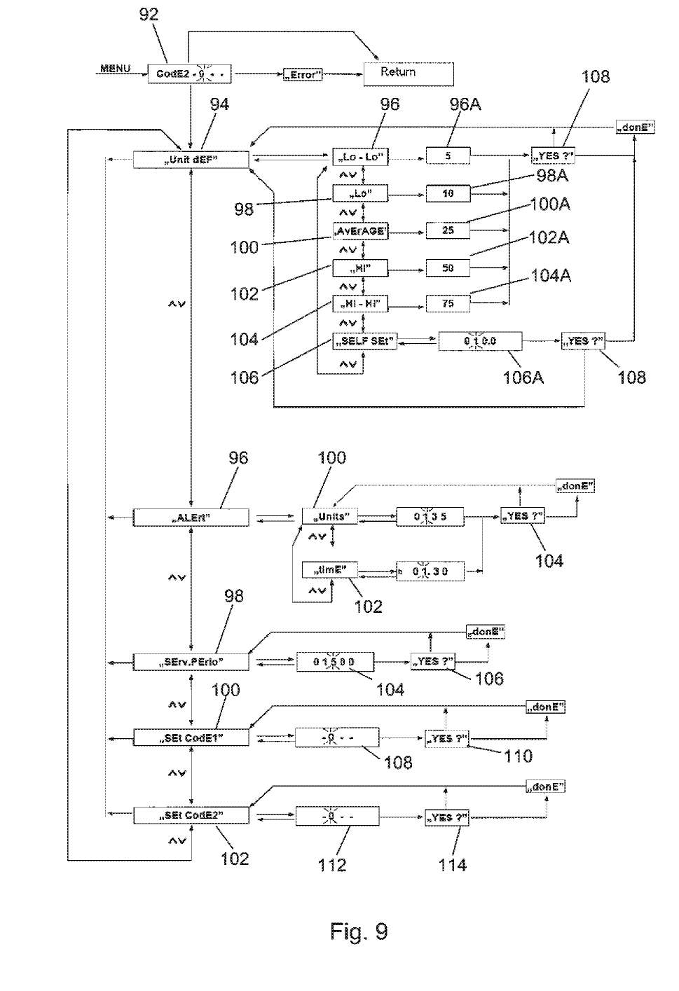

FIG. 9 shows steps involved in setting an apparatus according to a further embodiment of the present invention;

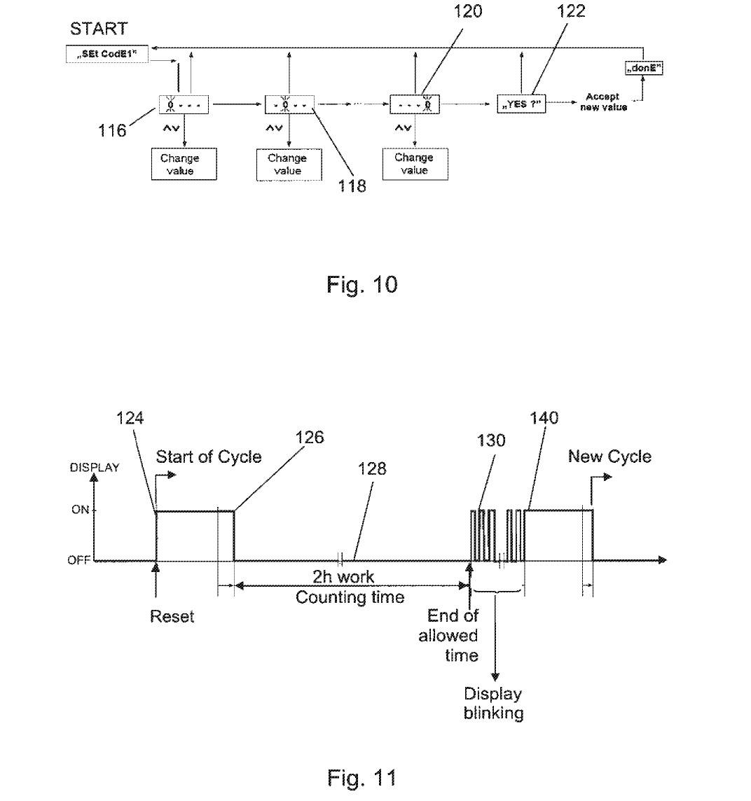

FIG. 10 shows operation of one embodiment of recognition means for use in accordance with the present invention;

FIG. 11 shows timings of operation of indication means during use of an apparatus in accordance with the present invention;

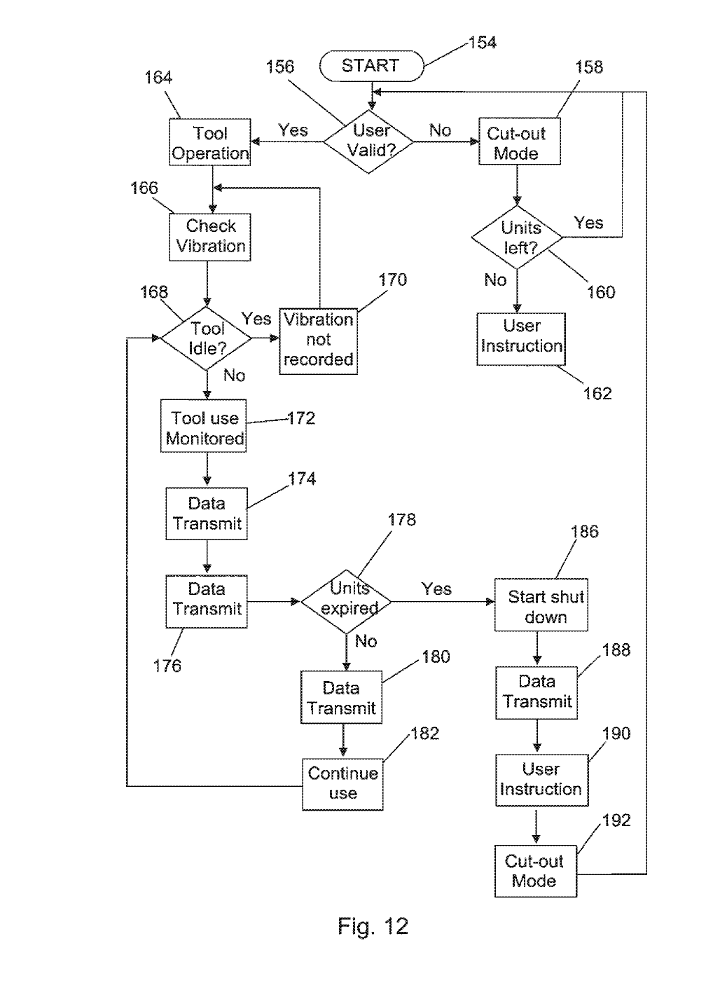

FIG. 12 shows an example of the usage steps for a tool according to one embodiment of the present invention;

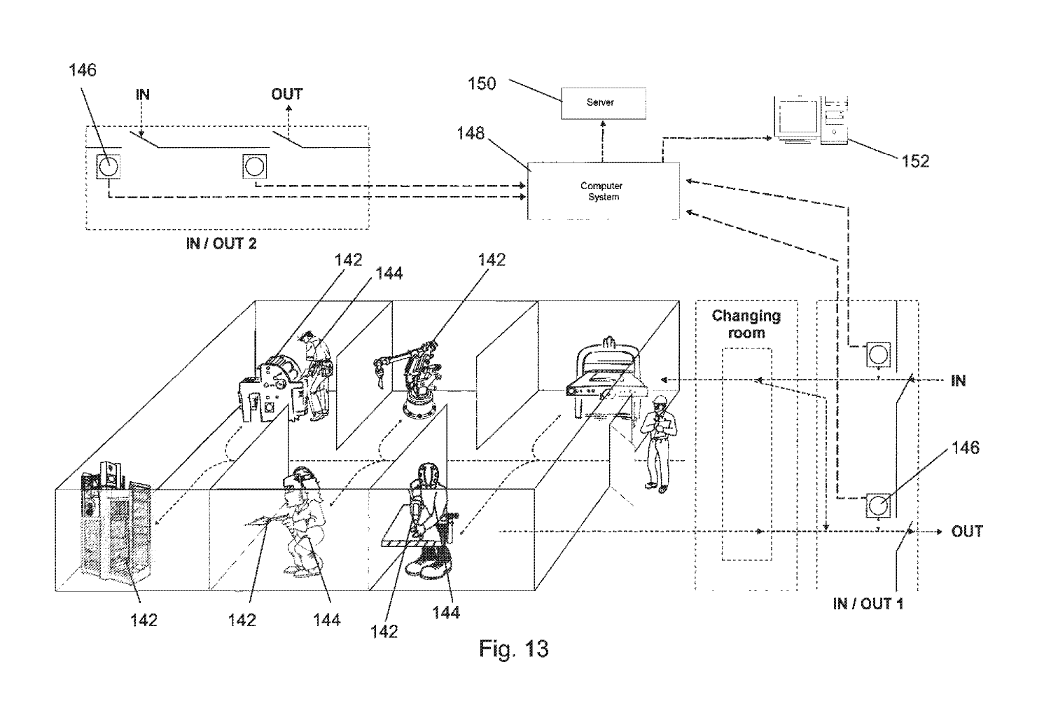

FIG. 13 shows a schematic of a system for monitoring use of multiple tools according to the present invention; and,

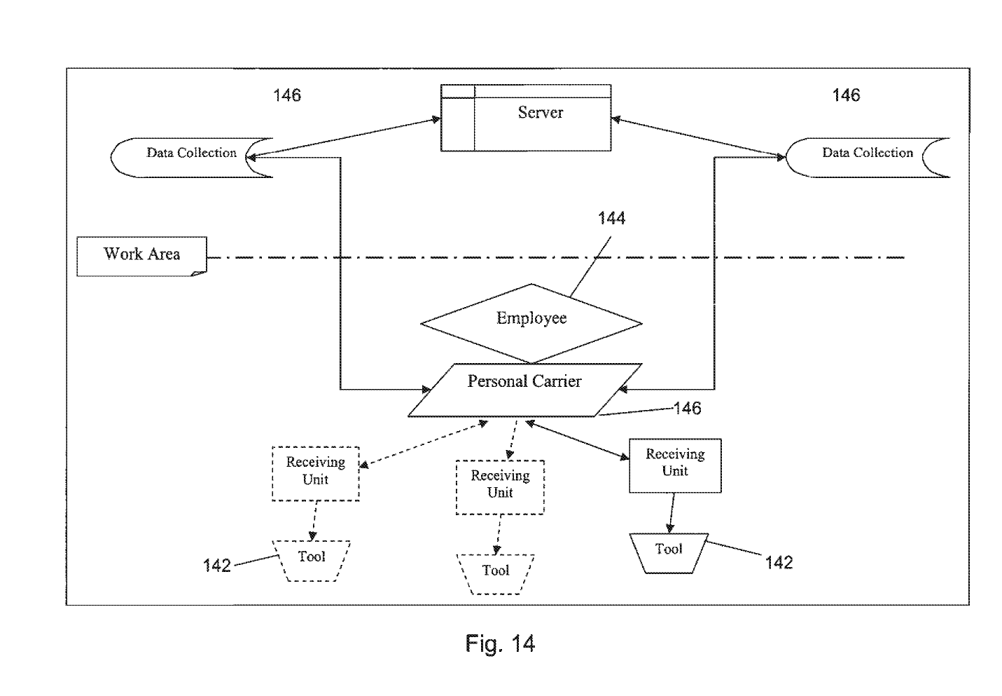

FIG. 14 shows the dataflow about a system for monitoring tool use according to the present invention.

The present invention provides for numerous embodiments of systems which offer improved monitoring of tool usage and greater control of the operation of individual tools by specific users by way of improved tool and worker management systems. Turning firstly to FIG. 1, there is shown a schematic of the basic component according to a first embodiment of the present invention which is for use in conjunction with an electric power tool. The components comprise sensing means in the form of a current sensor 10 which is connected to a power line 12 which supplies power to a power tool (not shown).

The current sensor 10 is connected to control means in the form of processor unit 14 such that the processor is arranged to receive a digital input signal from the current sensor 10 which corresponds to the flow of current to the power tool. As will be understood by a person skilled in the art, the processor clock can provide a timing function or else separate timing means can be connected to the processor if preferred.

A keyboard or key pad 16 is connected to the processor to allow manual input of codes, instructions or the like as will be described in further detail below. In some embodiments, the keyboard 16 allows for manual setting of operational data for the tool monitoring apparatus. It is also possible for the processor 14 to control whether or not certain keys are active such that access to certain functions of the tool monitoring apparatus is restricted.

Indication means in the form of a LCD display screen 18 and one or more LEDs 20 are also connected to the processor unit 14. The display screen 18 provides an alphanumeric output such that quantitative information or else instructions can be provided to a user under control of the processor 14. The LEDs 20 provide further visual indication means to alert a user when pre-determined conditions have been met. In this regard, multiple LEDs having different colours are provided, typically comprising green, red and/or orange colour codes.

FIG. 1 also indicates a power supply 22 which supplies power for normal operation of the tool and also to power the tool monitoring systems. The power supply may be local by way of a rechargeable cell or else power may be derived from the power line 12 which supplies power to the tool.

The processor unit 14 is also connected to a contactor or cut-out arrangement 26 via an output circuit 24. The contactor 26 is connected to the power line 12 and allows power to the tool to be selectively inhibited or allowed under control of the processor unit 14. The cut-out arrangement may have an at rest or default condition that power to the tool is inhibited or else that at least certain tool functions are inhibited. In the case of a fluid powered tool such as a pneumatic or petrol tool, the cut-out may take the form of a valve in the fuel supply.

During operation, the current sensor 10 detects the flow of current to the tool via the power line 12 and sends a corresponding signal to the processor unit 14. The processor unit 14 determines the duration for which power has been supplied to the tool and provides a corresponding output to display 18.

The processor unit also has threshold usage data, the setting of which is described in detail below, against which the processor compares the actual duration of tool usage in order to determine whether threshold conditions have been reached. Once the duration of power supply to the tool exceeds the threshold condition, a visual indication is provided to the user by way of the LED 20 or else by flashing of the display 18. In addition, once pre-determined safety threshold values have been reached or exceeded, the processor 14 sends a signal via output circuit 24 to the contact 26 to shut off the power to the tool in order to inhibit further operation.

It will be appreciated that the processor unit may either count up or count down to the threshold value in time units or associated usage units. In addition, the processor maintains a record of the usage time for an individual session and also the total usage time over a number of individual sessions. Thus the processor can take account for threshold values of usage by a user over extended time periods, such as, for example, a day, a week, a month, a year, or multiples thereof. This data is also used to monitor total tool usage time for the purpose of scheduling tool maintenance and the like.

Turning now to FIG. 2, a further embodiment is shown, a number of basic components of which are the same as those in FIG. 1 and which are identified using the same reference numerals. However, in FIG. 2, the display 28 includes an improved display screen which is capable of displaying graphical information as well as alphanumeric strings. Thus, the display 28 in this embodiment is capable of providing a more informative output about tool usage over time. The display 28 may be connected to the processor unit 14 by a normalized connector 30.

The embodiment of FIG. 2 also includes audio indication means in the form of a buzzer or speaker 32, which is controlled by the processor 14 and provides further indication means for use in conjunction with or else instead of the display 28 and/or LEDs 20 for supplying usage information to the tool or unit operator.

Amplifier and detection means 34 are also provided between the current sensor 10 and the processor 14 such the quantitative data about the flow of power to the power tool can be amassed by the processor rather than a simplified digital input. Such quantitative data may be indicative of the power consumed by the tool during use. Also as an alternative to the current sensor 10 and amplifier and detection means 34, a current detection sensor 36 may be used in conjunction with a matching circuit 38 for connection between the power line and the processor 14.

The embodiment of FIG. 2 is also intended for use as part of a larger tool monitoring system, in which data can be sent to and from a central management system, from which the operation of a number of tools by individual users can be monitored and/or controlled. Thus, FIG. 2 includes data transfer circuitry 40 which may comprise an external connector circuit for connection to the central management system or else a portable device so as to allow flow of data therebetween. In a preferred embodiment the data transfer means 40 may comprise a transmitter or transceiver arrangement so as to allow for wireless data transfer.

The embodiment of FIG. 2 also includes an infrared receiver 42 which may function as recognition means so as to recognize an infrared signal emitted from personal identification means or else to receive a data signal in order to allow control of the processor from the central management system. Such functionality may also be used in conjunction with FIG. 1 or any other embodiment of the invention. It will be appreciated that other forms of conventional receiver may be used for reception of radio signals or the like.

In FIGS. 1 and 2, there is also shown a sensor 35 connected to the processor 14. The vibration sensor 35 may be used instead of or else in addition to the current sensors 10 or 36 as will be described in relation to the usage of the device below. The sensor 35 may be attached to the tool itself or else may be worn by an operator of the tool, such as, for example, by way of a wrist band, or the like. The sensor 35 may be wired to the processor or else may be in wireless communication therewith. According to a preferred embodiment, the sensor 35 takes the form of a vibration sensor. However sensors for sensing operational characteristics of the tool may be used, such as a revolution counter for tools having rotating parts. In this regard it will be appreciated that such other operational sensors detect operational characteristics of a tool which have an impact on vibration of the tool. Such operational sensors thus also implicitly detect vibration-affecting characteristics and are intended to fall within the scope of the term ‘vibration sensors’ as used within this application.

A vibration sensor is particularly advantageous since it allows cut off values to be established in order to identify when the tool is idle (at low revs or vibration levels) and when the tool is being used for work (at higher revs or vibration levels). A vibration sensor such as a revolution counter can also be used to provide frequency data relating to the vibrations caused by revolving parts. These factors may be important to the monitoring of all tools but have been found to be particularly relevant to petrol powered tools.

Suitable vibration sensors may take the form of any or any combination of a strain gauge attached at one end to a moving part of the tool; a microphone or ultra-sonic transducer for measuring vibration sound after amplification; and/or a piezoelectric member.

However, it will be apparent to the person skilled in the art that other forms of sensors are available, such as, for example, torque sensors and contact or pressure sensors positioned to detect depression of a trigger or button by a user during operation.

According one embodiment, an accelerometer, such as a tri-axial accelerometer, may be used to detect vibration upon operation of the tool. The oscillation of an accelerometer can be used to determine characteristics of the vibration including amplitude and frequency. The direction of vibration is measured in 3 principal axes. In the embodiment comprising a wrist strap such that it generally resembles a watch-like housing, considering the user's forearm to represent a horizontal axis, the 3 axes represent approximately a vertical (perpendicular) axis, a lateral (left to right) axis and a longitudinal (back and forth) axis. The parameters used to assess the vibrational exposure of a user comprise the root means square of each single axis acceleration value of a frequency-weighted vibration transmitted by the user's hand.

By use of such sensing means the tool monitoring apparatus may be self-regulating in response to tool operational characteristics.

Turning now to FIG. 3, there is shown a basic arrangement of the sensor 35 and associated circuitry comprising the sensor member 37, an amplifier or amplification circuitry 39 and one or more filters 41, connected to the processor 14 or other suitable timer. Amplification and filtering of the sensed vibration characteristics is carried out such that the vibrational output of the tool can be determined with sufficient accuracy to allow calculation of the vibration-based variables for monitoring of the tool. Filtering of the sensed characteristics may require the filter 41 to comprise low pass and/or band-pass filtering portions and may comprise a multiple feedback bandpass filter. In one embodiment, an infinite impulse response (IIR) filter may be used.

The processor applies a frequency-weighting in order to determine the risks associated with the measured vibration frequencies. Total exposure to vibration over a given time period can then be calculated by accounting for vibrational exposure due to use of one or more tools within that time period. Different vibrational signatures can be categorized into different bands in order to determine a suitable length of safe exposure for a user. This threshold value can then be automatically set by the processor unit and stored.

In the event that the vibrational signature changes due to use of a different tool, a new threshold value can be calculated for a given day based upon the contribution of the earlier exposure in conjunction with the new vibrational signature. In order to simplify this calculation, a points system or risk ratio can be assigned to each power tool or process as described above such that each user has a predetermined number of usage units which can safely be used within a working day or multiple thereof.

The frequency range used in prediction of vibration injury risks may be restricted to 8 to 1000 Hz. In addition, the accelerometer would need to be able to measure accelerated values of at least between 2.5 and 5 m/S². However it is envisaged that a broader vibration range can be accounted for in order to measure vibrations associated with high frequency power tools. By way of example only, high frequency hand-held power tools may operate at 125V, 200 Hz (earth potential 72V) or 200V, 300 Hz (earth potential 115V).

Whilst a portable vibration measuring device which is specific to a user is in many ways preferred, it is to be noted that the accuracy of measurement of vibration requires an accelerometer to be placed near or on a vibrating surface and so the provision of an accelerometer in the form of a glove may allow the sensor to be moved closer to the vibrating tool. In an alternative embodiment, the device may be mounted within the tool itself or else may be removably attachable to various tools which have a common mounting portion on the housing. The accelerometer may thus be located in a portable unit, which is carried by the user, such as the identification means or keyfob according to any one of the embodiments described herein.

Furthermore a vibration measuring device which can be worn by a user can be used to detect various forms of vibration which emanate from power tools or other machinery. Thus a vibration measuring device can be used to detect environmental vibrations emanating from, for example, the floor or walls of a building so as to take account of vibrations on a larger scale which is not limited to individual tools.

Turning now to FIG. 4A, there is shown a tool monitor apparatus housing 44 designed to be connected to power line 12 and having a base 46 and a lid portion 48 which are joined at a lip 50 which extends around the periphery of the housing 44. The lip 50 may include a seal so as to prevent any ingress of dirt, or other unwanted materials. An aperture 52 is provided for a display screen as described in FIGS. 1 and 2. In addition, apertures 54 are provided for location of one or more LEDs 20. In this embodiment, the keyboard 16 is provided by way of a key pad 56 having a series of keys 58 to 64, the functions of which are described in further detail below.

In FIG. 4B it can be seen that each of the keys has dual functions, such that key 58 provides a clear button 58A and an up arrow 58B; key 60 provides a menu button 60A and an escape button 60B; key 62 provides a units entry key 62A and an enter button 62B; and key 64 provides a down arrow 64A as well as a timer key 64B.

The base 46 of the housing 44 can be seen in further detail in FIG. 5. The base has a pair of openings 66 and 68 through which a power lead (not shown) passes into and from the housing. A series of fixing holes 70 around flanges on the base 46 allow the base 46 to be attached to the lid 48 by screws or other conventional fixing means. The base 46 also comprises a series of raised formations, upon which a printed circuit board 74 can be positioned by inserting the PCB in the direction of arrow A as shown in FIG. 6. The PCB 74 can then be held in place using screws or other conventional fixing means such as clip fixings or the like. This form of housing is particularly advantageous, since it can accommodate different printed circuit boards and thus provides a housing which can be used either for an electric power supply or else in conjunction with a tool which is operated by way of fluid power, such as, for example, from a pneumatic or hydraulic power source.

When the housing 44 is intended for use with an electric power source, the entire power lead enters the housing via opening 66 and the individual elements of the power lead are connected to the appropriate connectors on the PCB 74. Appropriate connections are also made between the PCB 74 and the other side of the power lead as it exits through opening 68. Thus when the lid is sealed on the base 46, the discontinuity in the power lead is sealed so as to enclose the opposing ends of the power lead therein.

The display, buzzer, LEDs and other components are connected to the appropriate points on PCB 73 shown in FIG. 7, which carries the main processor for controlling operation of the unit. Similar to the arrangement of the base, the lid 48 comprises a series of raised formations on which the PCB 73 can be mounted in the direction of arrow B. A cover plate 75 is then attachable to the lid by screws or a conventional clip fixing arrangement to close off the PCB 73 within the lid cavity. In this embodiment, the sensors are mounted on the base PCB 74, which is separate from the lid PCB 73, such that different sensors for different types of power tool can easily be interchanged within the common global housing design.

When the housing 44 is intended for use with a pneumatic or hydraulic tool, the fluid power supply conduit enters and exits the housing via respective openings 66 and 68. A flow or pressure sensor can be mounted relative to the conduit as it passes through the housing in order to measure operation of the tool by the flow of working fluid thereto. With reference to FIGS. 1 and 2, the current sensors 10 or 36 can simply be replaced by a flow sensor when the tool monitoring apparatus is used in conjunction with a pneumatic or hydraulic tool. In addition the electrical cut out 26 can be replaced with a valve means in order to selectively shut off the flow of fluid to the tool as necessary.

The housing 44 is made of a suitable molded plastics material in order to provide the required durability and impact resistance for use in a workshop or similar industry environment.

FIG. 8 shows the basic steps involved in clearing the timer settings for the tool monitoring device. When power is supplied to the device at 76, a user can select to view either the current elapsed time 78, the total elapsed time 80 or else the service time 82. This is achieved by pressing the “timers” key 64B as shown in FIG. 4B. A user can scroll through the relevant timers and select the required timer using the enter key 62B.

The current timer displays the duration of usage of the tool in the current or most recent time interval, for example, in the current or most recent 24 hour period. The total time display 80 provides the user with an indication of the total duration of usage of the tool since the tool power was first installed or since it was last reset. The service time display 82 provides the user with an indication of either the usage of the tool since the last tool maintenance or else the tool usage remaining until the next tool maintenance will become due. Once the required display is selected, the user can elect to clear the relevant record on the timer memory by depressing the clear button 58A at step 84. In order to be able to complete the clear function, the user will be required to enter a code at step 86 prior to confirming that the clear function should be carried out at 88.

In addition, at step 90 the user can depress the units key 62A in order to set the units in which tool usage is displayed. Thus the user can elect to display duration of tool usage in hours, minutes and short seconds or else in alternative units of usage as will be described below.

Turning now to FIG. 9, there are shown the steps for manually setting threshold values of tool usage. Whilst this embodiment requires manual input of certain data, it will be appreciated that the same data can be automatically transmitted by a central management system or else by the apparatus processor 14 itself provided the necessary data is available.

In FIG. 9 the user enters a security code into the key pad at step 92. If accepted, a user can select from options 94 to 102 within a menu. Option 94 relates to setting of a conversion function in the form of risk ratio for the tool to be monitored. The risk ratio is indicative of the damaging nature of the vibrations produced by the tool during usage and may be calculated from the tools vibration signature, taking into account amplitude, frequency, direction and/or cyclic changes to the tool vibration signature during use. The risk ratio may therefore be provided by the tool manufacturer, or else may be calculated from vibration measurements taken during usage of the tool, or else may be derived from existing tool identification systems.

However it will be appreciated that the use of sensor 35 of FIGS. 1 and 2 may allow a device according to the present invention to be set automatically by measuring the vibrational output of a tool during use and calculating the relevant conversion function for that tool. Thus the use of a vibration sensor such as an accelerometer can replace or supplement the need for manual input of a risk ratio or else predetermined operational threshold values. In one embodiment, the tool may be initially set manually to provide initial values for the system and thereafter, the vibrational characteristics sensed by the accelerometer can be used to generate real-time operational data thereafter so as to monitor and amend the risk ratio and threshold values in accordance with the vibrational output of the tool during use.

A risk ratio can also be determined automatically at the start of usage of the tool and periodically checked to ensure that the tool vibration signature has not substantially altered over time. Dynamic risk ratios and thresholds can be determined and updated continuously or intermittently in accordance with the tool's operating conditions.

Every tool is prescribed with a predetermined number of arbitrary usage units to be used during a given time period. In the embodiment of the present invention, each tool and/or user is prescribed 100 usage units per working day. The risk ratio assigned to each tool is used to determine the relationship between the arbitrary usage units and actual time based on the operational characteristics of that tool. Thus the risk ratio determines the rate at which usage units are consumed over a given time period of actual tool usage. Thus a tool which generates more harmful vibrations will consume more units within one hour's use than a tool which produces less harmful vibrations.

It will be appreciated that the same number of usage units are prescribed to all tools and the risk ration thus determines how quickly the units are used upon operation of each tool. Thus a universal scale can be established which is common to all tools. However the actual number of units prescribed is arbitrary and can be varied without affecting the manner in which the system operates.

In this particular embodiment, the range of risk ratios is banded using the 5 predefined settings shown as options 96 to 104 which can be described as relating to risk ratios “very low”, “low”, “average”, “high”, and “very high”. For each of these settings, there is a prescribed number of units consumed per hour of usage of the tool which are shown in boxes 96A to 104A. In this embodiment, the number of units to be consumed per hour of usage of the tool is as follows:

Very low 5 units per hour.

Low 10 units per hour.

Average 25 units per hour.

High 50 units per hour.

Very high 75 units per hour.

It will be appreciated that different scales may be used as well as different bands. For example, more bands of a smaller range may be used for increased accuracy.

In addition, in this embodiment, there is a further option 106 which allows a user to set a different risk ratio for a particular tool. Thus a customized setting can be entered to correspond to a specific number of units per hour based upon vibration information made available to a user. Once option 106 is selected, the user is prompted to enter the number of units per hour to be consumed by tool usage at 106A. This is achieved by using the up and down arrows 58A and 64A as shown in FIG. 4B. Once the risk ratio is confirmed at step 108, the display returns to the menu options from where a user can exist the setting function or else select from one of the further options 96 to 102.

Option 96 allows a user to set the prescribed durations at which a user is alerted or else at which the tool is automatically shut off. At step 100 the operator can select to enter a number of usage units as a threshold or else, at step 102, a user can elect to enter a prescribed period of time as a threshold value. In the embodiment shown, the timer or counter will then count up or count down from this threshold value during usage of the tool. Once the prescribed threshold value of either time or usage units is reached, the processor 14 will then alert the user either by way of the flashing display 18, the LED 20 or else the buzzer 32.

The visual or audio alert will be provided for a predetermined time or number of usage units, typically equating to between 2 and 10 minutes, before the tool is automatically shut down. It is also possible for the operator to input the shut down threshold values or else the operator could separately input an alert threshold value and a shut down threshold value. Once the entered threshold value is confirmed at step 104, the user can return to the menu.

Option 98 allows a user to enter a service period at step 106, which is typically entered as time units in order to correspond with universally recognizable settings. This allows a time to be entered to correspond to a recommended service interval for the tool or related consumables. Thus the timer can be programmed to take account for wear of consumable parts, such as, for example, drill bits, sanding disks and the like. The operator is asked to confirm the selection at step 106.

Option 100 allows a user to set a level 1 security code by entering a 4 digit code at step 108 and then confirming the code at step 110. Option 102 allows a user to set a level 2 security code by entering a 4 digit code at step 112 and confirming the code at step 114.

Two different levels of security are provided for in order to allow access to certain functions to be restricted. Thus an end user may be able to select basic information which is to be displayed on screen 18 or 28 without the need to input a security code. A level 1 security code is required at step 86 in order to reset the elapsed tool usage time during the current session. A level 2 security code is required to reset the total tool usage and the service interval for options 80 and 82, as well as to set the risk ratios at threshold values and other settings shown in FIG. 9. The security access levels can be cancelled by setting the relevant codes to ‘0000’.

FIG. 10 shows the steps required to set or enter a security code using the key pad 56. A user depresses the up and down keys 58B and 64A in order to select the necessary digit at step 116 and then depresses the enter key 62B in order to enter that digit. This process is repeated for the second to fourth digits of the code at steps 118 to 120 before the final code is accepted at step 122. A 4 digit code is found to provide adequate security, although it will be appreciated that a greater or fewer number of digits within the security code can be used.

Returning now to FIG. 2, the manual entry of the security codes and/or settings may be replaced by use of a portable control device, such as a key fob or the like on which is stored the necessary security and/or operational settings data. The key fob transmits a data signal which is received by receiver 42 connected to processor 14 in order to simplify the method of setting the equipment. As an alternative, the key fob may include a chip which can be scanned by the apparatus to a similar effect. Whilst this automated procedure for setting threshold operation values is preferred, it is envisaged that a manual override will still be provided by way of the key pad 56 or else by remote WiFi or IR signal data transferal.

In FIG. 11, the operation of the display for one cycle of usage is shown. The cycle starts at 124 at which point the user operates the key pad in order to clear or set the operation settings of the tool monitoring device. Once the key pad has remained inoperative for a predetermined period of time, such as, for example, 30 seconds, the display is switched off while the tool is in use during time period 1 to 8. It will be appreciated that a user can check the remaining time during usage of the tool by depressing the corresponding key. After a predetermined threshold of work time has elapsed, the display flashes during period 130 in order to indicate the end of the allowable work time. Then, once work is finished, the key pad is operated to reset or re-enter operational settings at 140 for start of a new cycle.

In FIG. 12 there is shown a series of functional steps for operation of the tool monitoring apparatus. At step 154, power is supplied to the tool monitoring apparatus. The tool is in a default cut-out condition in which power or fluid flow to the tool is inhibited. This may be achieved for an electrically powered tool by virtue of a switch or diode arrangement which shuts off power to the tool or else by way of a power control circuitry which allows power for only certain tool functionality. Typically such an arrangement will not provide sufficient power for usual operation of the tool.

At 156, the IR receiver 142 checks for an IR signal from a user's personal data carrier such as a keyfob. Additionally or alternatively, the apparatus may check whether a valid user code has been input using the keypad as described above. If a user's signal or data input is recognised, power is provided to the tool.

Otherwise, the apparatus proceeds to step 158 in which the tool remains in cut-out mode such that the tool's primary function is inoperative. However in this condition the tool can still operate a routine at 160 to determine whether the user has any outstanding tool usage units left to use for the current time period (e.g. that day). In the event that a user has no usage allowance left or else if the user is not recognised by the apparatus or not permitted to operate the tool in question, the apparatus displays a message to the user on the display screen 18 or 28, informing the user to seek assistance or else informing the user that they are not permitted to operate the tool. The tool then returns to an idle mode awaiting a further user signal or data input at 156.

In the event that a user is recognised as having usage allowance remaining, the apparatus supplies normal operational power to the tool such that the tool can be operated at step 164. The apparatus determines the vibration magnitude generated by the tool in use by virtue of sensor 35 at step 166. Such characteristics may be measured over a predetermined time period such as for example a few seconds of use.

At step 168 the sensed vibration characteristic, such as for example the vibration magnitude and/or frequency is compared to a preset threshold value in order to determine whether or not the tool is idle. If the sensed value is below the threshold value, the tool is considered to be idle and the apparatus proceeds to step 170, at which the apparatus does not register the tool vibration as usage of the tool against the user's allowance. The apparatus then enters a loop to continue checking the tool vibration until either the tool operation ceases or else the threshold vibration magnitude is exceeded.

When the tool vibration exceeds the threshold value at step 168, it is determined that the tool is being operated by the user (anger time). The apparatus records usage of the tool continually or else intermittently at step 172. At step 174, the vibration magnitude and/or frequency are checked against the preset or pre-recorded values for the tool in order to determine the accuracy of the risk ratio associated with that tool. If the vibration levels match the expected values or are sufficiently close thereto, then the user's usage units are consumed at the predetermined rate determined by the risk ratio. In the event that the operational characteristics of the tool deviate from the predicted values, then the risk ratio is recalculated and the user's units are consumed at the new rate.

At step 176 the apparatus data transmission means transmits the usage data to a central management system, typically comprising a server, where usage of a number of tools can be logged. In addition the apparatus may also transmit the usage data to the user's personal data carrier at this step. Data transmission can be wired or wireless as will be appreciated by a person skilled in the art and may be via a radio signal such as Bluetooth®, RFID technology or else using IR signals.

The data transmission will comprise data indicating the user and tool in use as well as the time and/or units consumed during that use. Steps 174 and 176 may be repeated intermittently. Alternatively the data transmission may be carried out only at the end of a continual usage period, for example, when the user deactivates the tool.

At 178, the processor 14 checks whether or not the user's unit count is zero for the current time period. If all the user's usage units have been consumed, the apparatus commences a tool shut-down procedure at 186, whereby a data signal is sent to the user's personal data carrier and/or the central management server at 188, indicative of expiry of the user's units for that time period. The apparatus displays a visual indication of the same to the user at 190 and then enters cut-out mode at 192 such that further use of the tool is inhibited for that user during that time period. The cut-out may be delayed form the user indication by a short time period, such as for example between 10 seconds and 10 minutes dependent on the type of tool being used.

If units are left, the apparatus may transmit data indicative of continued use to the user's personal data carrier and/or the central management server at step 180 and the use of the tool may continue. Any or all data transmission may include the date and time of the transmission or data log, which may be used to keep records for each user and/or tool.

FIG. 13 shows an overview of the system for monitoring the usage of multiple tools within one or more premises. The individual monitoring apparatus associated with each tool may be as shown in FIG. 2, although the data transfer means 40 preferably comprises transmission means for wireless transfer of data. Various tools or work stations 142 are shown, each of which has an associated tool monitoring device according to the present invention. The users 144 each carry identification means in the form of a key fob or remote controller.

In order to commence operation of the tool, the user is required to input a personal identification code, or else transfer identification data to the reception means associated with the tool monitoring apparatus. Thus tool usage is recorded for each user.

During use of the tool, usage data is continually or intermittently transmitted to one or more receivers 146 connected to a computer system 148 which includes a server 150. The transmitted data therefore includes details of the period for which the user has been operating a tool, indication of the tools which have been operated, including the risk levels associated with that tool, and also an indication of the tool being operated. This data is received and fed to the computer system for processing by a conventional CPU in order to generate logs of usage history for each user and each tool.

It is also possible in an alternative embodiment that the data is processed by the processor 14 on the tool timing apparatus. However, the central processing of this data has been found to beneficially reduce the necessary size of the tool timing apparatus and the associated costs of the components and the manufacture thereof. Data specific to a user may also be saved on the memory of a user's keyfob.

The usage history data is stored such that it is accessible via a operator terminal 152 from which an operator can view maintenance schedules, tool usage and user history. This information can be used to review productivity and also to schedule future work and assign workers to specific tools with greater efficiency.

In addition to using individual identification means to activate tools, users are required to register their identification means upon entry or exit from the premises at readers 146. Thus information regarding those workers who are present in the premises can be reported to an operator for real management of the workforce and also to monitor whether individual workers are fulfilling their contracted work hours as well as health and safety requirement.

The data flow around the system is shown in FIG. 14, in which employees 144 each have a personal data carrier 146 to which their personal user ID and usage data is stored. 100 ‘units’ are typically allocated to each employee at start of day. However a variable units value may be allocated to certain employees on an individual basis, such as for example if the user requires a lower value for medical or legal reasons. For this reason, the system allows anywhere between 0 and 100 units to be allocated to a user for a given time period.

In the embodiment shown, the system typically has on or more data collection points 146 which may comprise receivers or transceivers arranged to receive signals from the plurality units. The line 147 represents a boundary of a wireless transmission zone within which the system is operable. Thus the range of any wireless transmission devices can be tailored to suit the required radius or area of coverage. The measured vibration magnitude and usage values are transmitted either directly from the tool monitoring apparatus to Data Collection points 146 or else indirectly via a user's personal data carrier 146. In addition, any transmitted data signals may comprise machine readable instructions for control of the tool monitoring apparatus.

Thus when an employee's allocated units have elapsed, employee will not be able to activate any tools within the workplace.

In one embodiment, the data carrier can act as security device allowing employees into the work area and may also provide for management of workflow processes (e.g. equipment delivery, next level work activity), management of individuals by virtue of logging their whereabouts and utilities costs which are dependent upon tool usage.

Whilst particularly suited to multiple workers or employees, the system according to the present invention may be used in any environment in which one or more people are operating tools or machinery.

What is claimed is:

1. A system for monitoring usage of one or more power tools, the system comprising:
a setting assembly configured to set a prescribed extent of usage of a tool, the prescribed extent being determined by conversion of usage units into time units using a conversion function specific to the tool, wherein the conversion function is dependent upon operational characteristics of the tool;
a sensor configured to sense a usage of the tool;
a timer configured to time a duration of usage of the tool in accordance with the sensor; and,
a controller configured to provide an indication when the timed duration of usage of the tool reaches or exceeds the prescribed duration.

2. A system according to claim 1, wherein the conversion function is determined with respect to vibrational characteristics of the tool.

3. A system according to claim 2, wherein the conversion function is a risk ratio.

4. A system according to claim 1, further including an audio or visual indicator operable by the controller to provide the indication upon expiry of the prescribed extent of usage.

5. A system according to claim 1, wherein the controller is arranged to inhibit operation of the tool after the prescribed extent of usage has expired.

6. A system according to claim 5, wherein the controller is arranged to inhibit operation of the tool a predetermined time period after providing the indication to a user.

7. A system according to claim 1, further including an identification assembly for identification of an individual tool user.

8. A system according to claim 7, wherein the identification assembly includes a keypad for entry of a code specific to an individual user.

9. A system according to claim 7, wherein the identification assembly includes a portable unit having a memory for storing identification data specific to an individual user.

10. A system according to claim 7, wherein a log of tool usage data specific to the user is stored by the system.

11. A system according to claim 10, wherein the prescribed duration of usage is determined by the setting assembly automatically based upon a sensed operational characteristic of the tool which is monitored during use of the tool.

12. A system according to claim 11, wherein the conversion function for the tool is checked against the sensed values of the operational characteristic and updated automatically in the event that the operational characteristic varies over time with use of the tool.

13. A system according to claim 7, wherein the controller inhibits operation of the tool until a user has been identified by the identification assembly.

14. A system according to claim 1, further including a central management assembly comprising a database of users and tool usage history for each user.

15. A system according to claim 14, including a signal transmission assembly associated with the tool for the transmission of usage data to the central management assembly.

16. A system according to claim 15, wherein the transmission assembly continually transmits a wireless data signal to the central management assembly.

17. A system according to claim 1, wherein the sensor senses one or more operational characteristics of the tool and the controller compares the sensed level of the operational characteristic to one or more predetermined values of the operational characteristic in order to determine whether the tool is idle or in use.

18. A system according to claim 17, wherein the operational characteristic at least one of a combination of power supplied to the tool, vibrational output of the tool, revolutions of the tool for a given time period and the operation of tool actuation means.

19. A system according to claim 1, wherein the sensor includes a variable resistor.

20. A system according to any one of claims 1, wherein the sensor includes a vibration sensor.

21. A system according to claim 21, wherein the vibration sensor includes a piezoelectric member.

22. A system according to claim 20, wherein the vibration sensor is located in an article of attire which can be worn by a user.

23. A system according to claim 22, wherein the vibration sensor is located in a wrist strap.

24. A system according to claim 22, wherein the vibration sensor is located in a glove.

25. A system according to claim 20, wherein the prescribed duration of usage is automatically set by the setting assembly in accordance with the instantaneous vibration level measured by the vibration sensor.

26. A system according to claim 25, wherein the duration of usage is dynamically adjustable in response to changes to the operational vibration level of the tool.

27. A system according to claim 1, wherein the setting assembly includes a keypad for manual data input.

28. A system according to claim 1, wherein access to certain system functions is restricted.

29. A system according to claim 28, wherein a plurality of security levels are provided and access to one or more functions at each security level requires provision of a data key.

30. A system according to claim 28, wherein a first system security level allows use of the tool and a second security level allows setting of the extent of at least one of tool usage and conversion function.

31. Apparatus for monitoring vibrations experienced by a user, wherein the apparatus comprises:
a vibration sensor configured to sense a characteristic of vibrations experienced by a portion of the user's body;
a timer configured to record a time period during which the characteristic is sensed;
a controller configured to compare the characteristic of the vibrations against a predetermined threshold value; and,
an indicator configured to indicate to the user when the sensed characteristic or duration reaches or exceeds the threshold value.

32. Apparatus according to claim 31, wherein the controller converts recorded time of usage of a tool into a value of usage units by application of a conversion function based on the sensed vibrational characteristic of the tool.
